(19) United States
(12) Patent Application Publication
(10) Pub. No.: US 2016/0300630 A1
(43) Pub. Date: Oct. 13, 2016

(54) METHOD OF SYNTHESIZING AXIAL POWER DISTRIBUTIONS OF NUCLEAR REACTOR CORE USING NEURAL NETWORK CIRCUIT AND IN-CORE MONITORING SYSTEM (ICOMS) USING THE SAME

(71) Applicant: KEPCO Nuclear Fuel Co., Ltd, Daejeon (KR)

(72) Inventors: Young Ho Park, Daejeon (KR); Young Baek Kim, Daejeon (KR); Hye Jin Kim, Daejeon (KR); Young Jae Choi, Daejeon (KR); Kyoung Woo Shim, Daejeon (KR)

(73) Assignee: KEPCO Nuclear Fuel Co., Ltd, Daejeon (KR)

(21) Appl. No.: 14/857,740

(22) Filed: Sep. 17, 2015

(30) Foreign Application Priority Data
Apr. 13, 2015 (KR) 10-2015-0051667

(51) Int. Cl. G21C 17/01; G06N 3/08; G06F 17/14; G06N 3/04

(52) U.S. Cl. CPC G21C 17/01; G06N 3/04; G06N 3/08; G06F 17/14

(57) ABSTRACT

There are provided a method of synthesizing axial power distributions of a nuclear reactor core using a neural network circuit and an in-core monitoring system (ICOMS) using the same, in which using the neural network circuit including an input layer, an output layer, and at least one hidden layer, each layer being configured with at least one node, each node of one layer being connected to nodes of the other layers, node-to-node connections being made with connection weights varied based on a learning result, optimum connection weights between the respective nodes constituting the neural network circuit are determined through learning based on various core design data applied to the design of a nuclear reactor core of a nuclear power plant, and axial power distributions of the nuclear reactor core are synthesized based on in-core detector signals measured by in-core detectors during operation of a nuclear reactor, thereby more accurately replicating axial power distributions of the nuclear reactor core throughout an overall period of fuel.

### BACKGROUND

1. Field of Invention

The present invention relates to a method of synthesizing axial power distributions of a nuclear reactor core using a neural network circuit and an in-core monitoring system (ICOMS) using the same. More particularly, the present invention relates to a method of synthesizing axial power distributions of a nuclear reactor core using a neural network circuit and an ICOMS using the same, in which using the neural network circuit including an input layer, an output layer, and at least one hidden layer, each layer being configured with at least one node, each node of one layer being connected to nodes of the other layers, node-to-node connections being made with connection weights varied based on a learning result, optimum connection weights between the respective nodes constituting the neural network circuit are determined through learning based on various core design data applied to the design of a nuclear reactor core of a nuclear power plant, and axial power distributions of the nuclear reactor core are synthesized based on in-core detector signals measured by in-core detectors during operation of a nuclear reactor, thereby more accurately replicating axial power distributions of the nuclear reactor core throughout an overall period of fuel.

2. Description of the Prior Art

In the case of an OPR1000 type or APR1400 type nuclear reactor operated in Korea, an In-core monitoring system (ICOMS) is operated for monitoring an operation state of a nuclear reactor core based on measurement data obtained through in-core detectors disposed inside the nuclear reactor core.

The ICOMS allows an operator to accurately monitor a state of the core based on various detector information and calculation results of main core operation variables. Particularly, the ICOMS plays a role in warning the operator of, if any, the possibility of operating stop. To this end, it is essentially required to detect axial power distributions of the nuclear reactor core based on detection values detected by the in-core detectors disposed inside the nuclear reactor core.

Accordingly, in a current ICOMS of Korean Standard Nuclear Power Plant (OPR1000), as shown in FIG. 1, in-core detector assemblies 20 capable of measuring in-core neutron flux distributions in a nuclear reactor core 1 are inserted into some nuclear fuel assemblies 10 in the nuclear reactor core 1, thereby acquiring data for calculating an axial power distribution. Here, the number of in-core detector assemblies reaches a total of 45.

In this case, each in-core detector assembly 20 includes five rhodium detectors 21, as shown in FIG. 2. When an effective core height is set to 100, the rhodium detectors 21 are respectively provided at positions of 10%, 30%, 50%, 70%, and 90% of the effective core height, to measure in-core neutron flux signals of five levels in the axial direction of the core.

Here, a conventional ICOMS, as disclosed in Korean Patent No. 10-0368325, entitled “A RECONSTRUCTION METHOD OF AXIAL POWER SHAPES IN COREMONITORING SYSTEM USING VIRTUAL IN-CORE DETECTORS” (Korean Hydro and Nuclear Power Co. LTD. and Korean Electric Power Corporation), registered on Jan. 1, 2003, is configured to calculate axial core average powers of the five levels based on in-core detector signals measured by a total of 225 in-core rhodium detectors existing in the nuclear reactor core, and synthesize axial power distributions of the nuclear reactor core using a Fourier series, based on the calculated axial core average powers of the five levels.

That is, the number of rhodium detectors 21 located at 10% of the effective core height, is a total of 45 in the radial direction of the core, as shown in FIG. 1. Therefore, dynamic compensation based on a time delay is performed on each of in-core detector signals measured by the 45 rhodium detectors, a power of a corresponding nuclear fuel assembly is calculated by providing the compensated signal with a weight value based on a rod shadowing effect and a burnup, and an axial core average power at the position of 10% is then calculated by averaging the powers of the nuclear fuel assemblies.

Thereafter, axial core average powers at the respective levels (i.e., the positions of 10%, 30%, 50%, 70%, and 90% of the effective core height) are calculated in the manner described above. Then, each of thus calculated axial core average powers of the five levels is normalized as a sum of all core average powers for each level, thereby obtaining normalized axial core average powers of the five levels.

Thereafter, axial power distributions of the nuclear reactor core are synthesized using a Fourier series as shown in the following Equation 1, based on the normalized axial core average powers of the five levels thus obtained as described above.

$${P}_{a} ( z ) = {a}_{1} cos \{ π B ( z - \frac{1}{2} ) \} - {a}_{2} sin \{ 2 π B ( z - \frac{1}{2} ) \} - {a}_{3} cos \{ 3 π B ( z - \frac{1}{2} ) \} + {a}_{4} sin \{ 4 π B ( z - \frac{1}{2} ) \} + {a}_{5} cos \{ 5 π B ( z - \frac{1}{2} ) \} \qquad Equation 1$$

Here, Pₐ(z) is an axial power distribution, a₁ to a₅ are Fourier coefficients, B is a buckling constant, and z is an axial node position of the core.

As such, in order to synthesize axial power distributions of the nuclear reactor core according to a conventional art, the Fourier coefficients a₁ to a₅ of the Fourier series shown in Equation 1 are determined using the calculated axial core average powers of the five levels, and an axial core average power at a corresponding node is calculated by substituting a node position z of an axial core average power to be sought, so that an actual axial power distribution can be replicated. If an axial power distribution is calculated in this manner, the axial power distribution can be relatively accurately replicated at the beginning of a period in which the shape of the axial power distribution mainly has a cosine form. However, a calculation error gradually increases since after the middle of the period in which the shape of the axial power distribution has a saddle form. Therefore, there is a problem that the actual axial power distributions are not properly replicated.

In the conventional art described above, five trigonometrical functions having different periods are used as the Fourier series for calculating an axial power distribution as shown in Equation 1. In this case, there is a problem that powers of topmost and bottommost portions of the core become zero. In order to address the problem, the buckling constant B is used as shown in Equation 1.

The buckling constant should be differently applied according to kinds of cores and design characteristics. However, it is difficult to select an optimum buckling constant for each nuclear power plant. Hence, the same value has been commonly applied to all nuclear power plants till now. Therefore, there is a problem that axial power distributions according to the kinds of cores and the design characteristics are not properly replicated.

### SUMMARY

Accordingly, the present invention is conceived to solve the aforementioned problems in the prior art. An object of the present invention is to provide a method of synthesizing axial power distributions of a nuclear reactor core using a neural network circuit and an in-core monitoring system (ICOMS) using the same, in which using the neural network circuit including an input layer, an output layer, and at least one hidden layer, each layer being configured with at least one node, each node of one layer being connected to nodes of the other layers, node-to-node connections being made with connection weights varied based on a learning result, optimum connection weights between the respective nodes constituting the neural network circuit are determined through learning based on various core design data applied to the design of a nuclear reactor core of a nuclear power plant, and axial power distributions of the nuclear reactor core are synthesized based on in-core detector signals measured by in-core detectors during operation of a nuclear reactor, thereby more accurately replicating axial power distributions of the nuclear reactor core throughout an overall period of fuel.

According to an aspect of the present invention for achieving the objects, there is provided a method of synthesizing axial power distributions of a nuclear reactor core using a neural network circuit, which is applied to an ICOMS for monitoring an operation state of a nuclear reactor based on in-core detector signals measured by a plurality of in-core detector assemblies, wherein the neural network circuit includes an input layer configured to receive a core average power of the nuclear reactor core for each of a plurality of axial levels, calculated based on in-core detector signals measured by the plurality of in-core detector assemblies; an output layer configured to output an axial core average power for each node calculated through the neural network circuit; and at least one hidden layer interposed between the input layer and the output layer to connect the two layers to each other, wherein each of the input, output, and hidden layers is configured with at least one node, each node of one layer being connected to nodes of the other layers, node-to-node connections being made with connection weights varied based on a learning result, so that optimum connection weights between the respective nodes constituting the neural network circuit are determined through repetitive learning based core design core design data applied to the design of the nuclear reactor core of a nuclear power plant.

### DESCRIPTION OF THE DRAWINGS

The above and other objects, features and advantages of the present invention will become apparent from the following description of a preferred embodiment given in conjunction with the accompanying drawings, in which:

FIG. 1 is a view illustrating a form of a core of a Korean standard nuclear power plant and installation positions of in-core detector assemblies;

FIG. 2 is a view illustrating a disposition of five axial rhodium detectors constituting one in-core detector assembly;

FIG. 3 is a flowchart illustrating a method of synthesizing axial power distributions according to an embodiment of the present invention;

FIG. 4 is a view illustrating a configuration of a neural network circuit for synthesizing axial power distributions according to the embodiment of the present invention;

FIG. 5 is a view illustrating a configuration of a neural network circuit for calculating core average powers of 40 nodes according to an embodiment of the present invention;

FIG. 6 is a view illustrating a configuration of a neural network circuit for calculating core average powers of 20 nodes according to an embodiment of the present invention;

FIG. 7 is a flowchart illustrating a learning process of the neural network circuit through a back-propagation (BP) algorithm according to an embodiment of the present invention; and

FIG. 8 is a graph illustrating an example in which an error converges on a local or global minimum value through the BP algorithm based on an initial connection weight in the learning of the neural network circuit through the BP algorithm according to the present invention.

### DETAILED DESCRIPTION

Hereinafter, exemplary embodiments of the present invention will be described in detail with reference to the accompanying drawings. Throughout the drawings, like reference numerals are used to designate like elements.

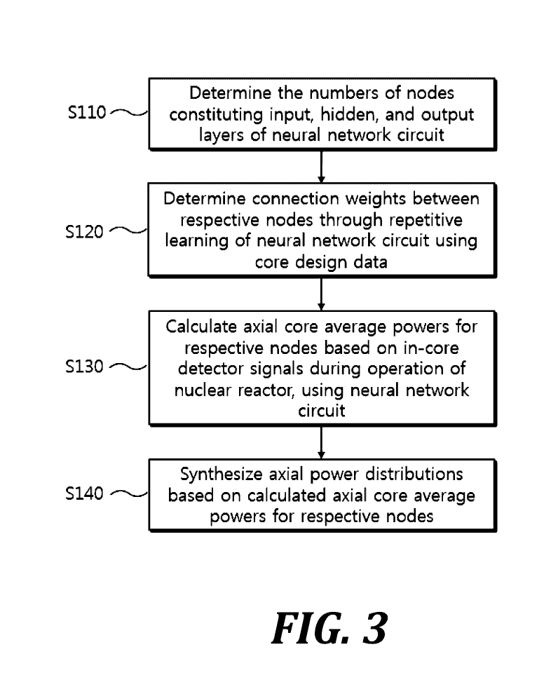

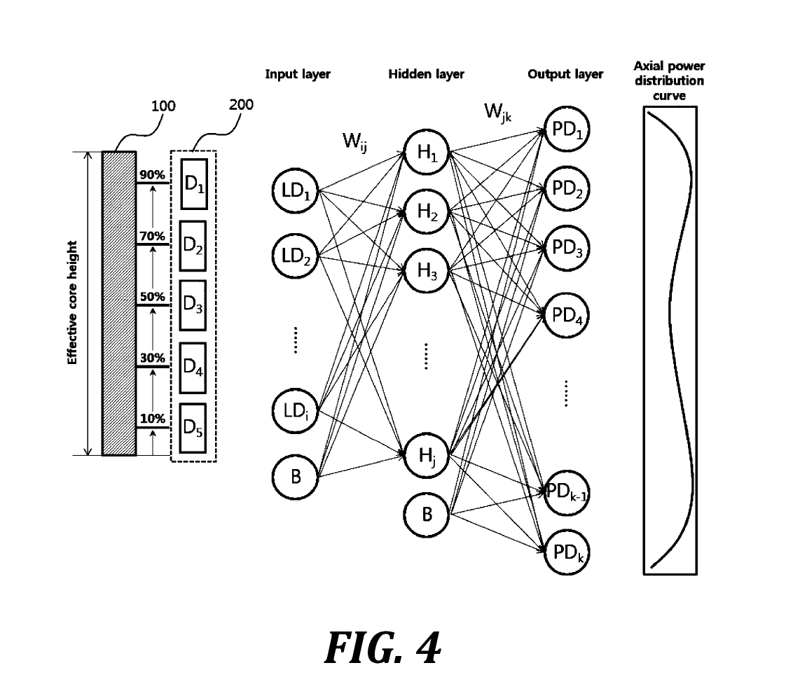

FIG. 3 is a flowchart illustrating a method of synthesizing axial power distributions according to an embodiment of the present invention. FIG. 4 is a view illustrating a configuration of a neural network circuit for synthesizing axial power distributions according to the embodiment of the present invention.

Referring to FIGS. 3 and 4, there are provided a method of synthesizing axial power distributions of a nuclear reactor core using a neural network circuit and an in-core monitoring system (ICOMS) using the same according to an embodiment of the present invention, in which, in a neural network circuit including an input layer, an output layer, and at least one hidden layer, the method is configured to determine the number of nodes LDᵢ constituting the input layer, the number of nodes Hⱼ constituting the hidden layer, and the number of nodes PDₖ constituting the output layer (S110), allow the neural network to learn through a back-propagation (BP) algorithm and a simulated annealing (SA) method by inputting various core design data applied to the design of a nuclear reactor core, to optimize the neural network by determining optimum connection weights (i.e., weight values Wᵢⱼ, and Wⱼₖ) among the respective nodes LDᵢ, Hⱼ, and PDₖ (S120), calculate axial core average powers for the respective nodes based on in-core detector signals measured by in-core detectors D₁, D₂, D₃, D₄, and D₅ during operation of a nuclear reactor, using the optimized neural network (S130), and then synthesize, in real time, axial power distributions of the core based on the calculated axial core average powers for the respective nodes (S140).

In other words, a method of synthesizing axial power distributions of a nuclear reactor core using a neural network circuit and an ICOMS using the same according to the present invention have advantages in that using the neural network circuit including an input layer, an output layer, and at least one hidden layer, each layer being configured with at least one node, nodes of one layer are connected to nodes of the other layers, and node-to-node connections are made with connection weights varied based on a learning result, optimum connection weights between the respective nodes constituting the neural network circuit are determined through learning based on various core design data applied to the design of a nuclear reactor core of a nuclear power plant, and axial power distributions of the nuclear reactor core are synthesized based on in-core detector signals measured by in-core detectors during operation of a nuclear reactor, so that it is possible to solve a problem that actual axial power distributions are not properly replicated as a calculation error gradually increases since after the middle of the period in which the shape of the axial power distribution has a saddle form in the conventional ICOMS using a Fourier series, thereby more accurately replicating axial power distributions of the nuclear reactor core throughout an overall period of the nuclear fuel, and so that a buckling constant is commonly applied to all nuclear power plants having different kinds of cores and design characteristics without the need for selecting and applying different optimum buckling constants for correcting the Fourier series at the respective nuclear power plants having the different kinds of cores and design characteristics, thereby more accurately replicating axial power distributions of the core.

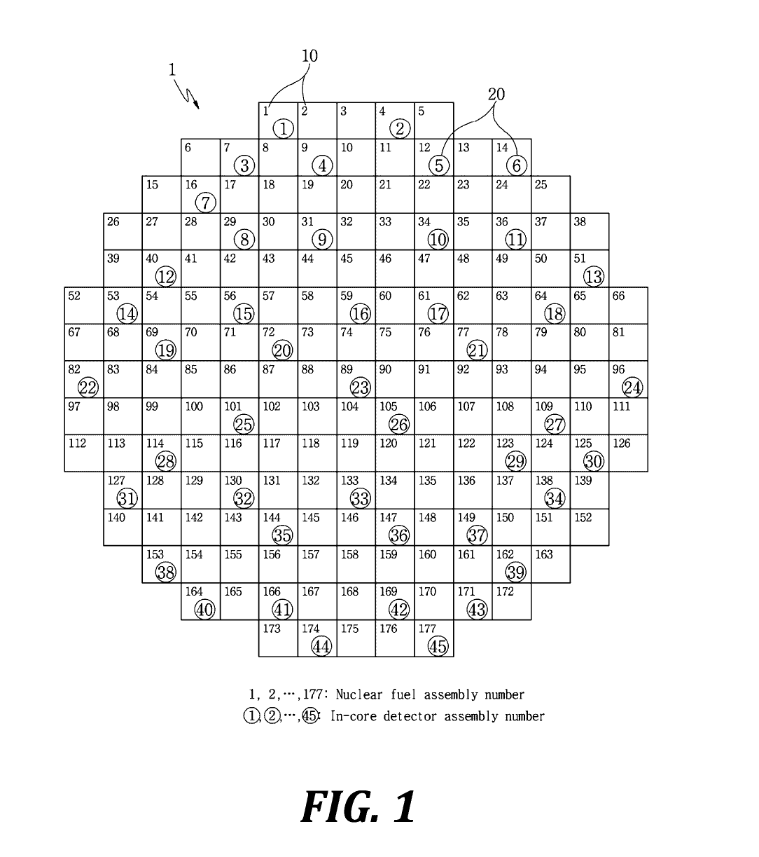

Hereinafter, a method of synthesizing axial power distributions of a nuclear reactor core using a neural network circuit and an ICOMS using the same according to the present invention will be described in detail for each step based on the flowchart of FIG. 3 with reference to FIGS. 1 and 4 to 8.

It is apparent that although this embodiment as shown in FIG. 1 will be described based on a Korean standard nuclear power plant (OPR1000 type nuclear reactor) configured with 177 nuclear fuel assemblies and 45 in-core detector assemblies, the present invention is not limited thereto and may be applied and used to nuclear reactors of various structures in the same manner.

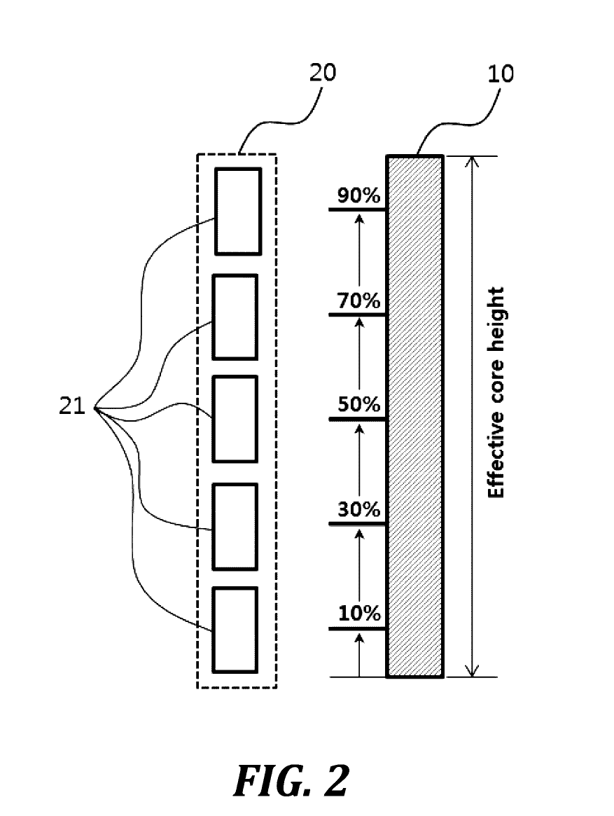

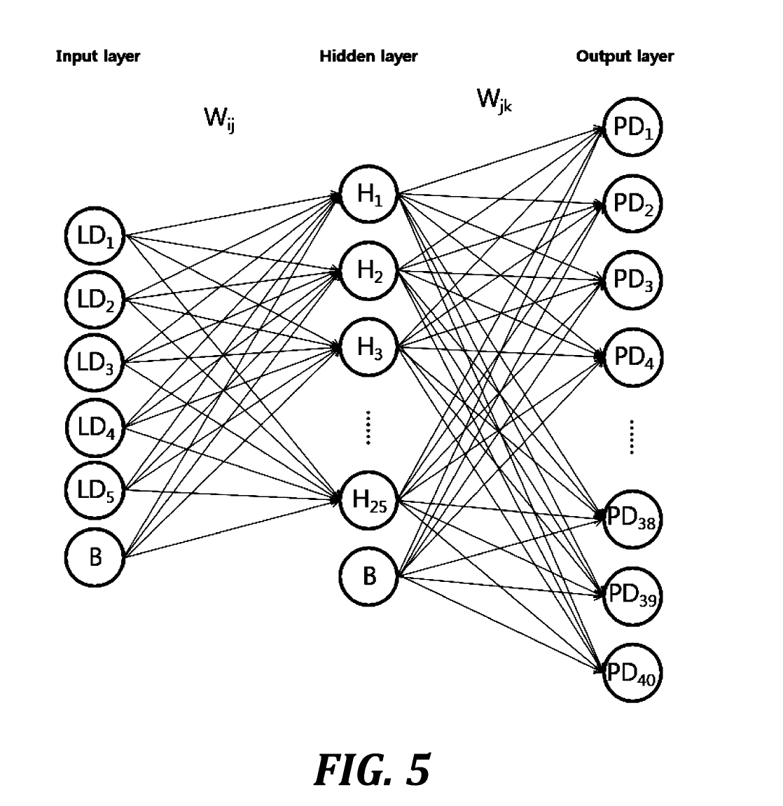

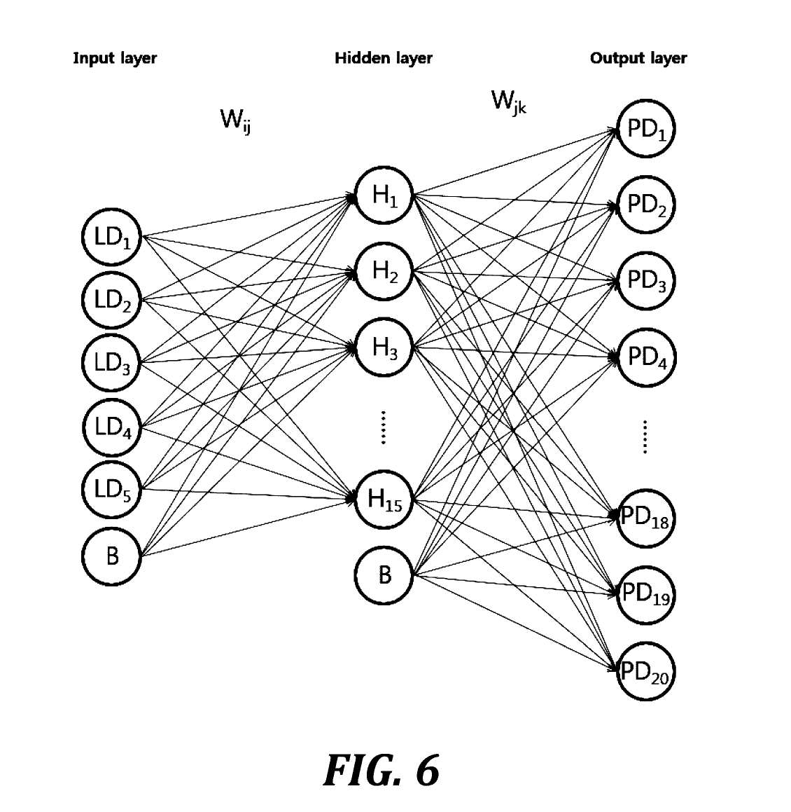

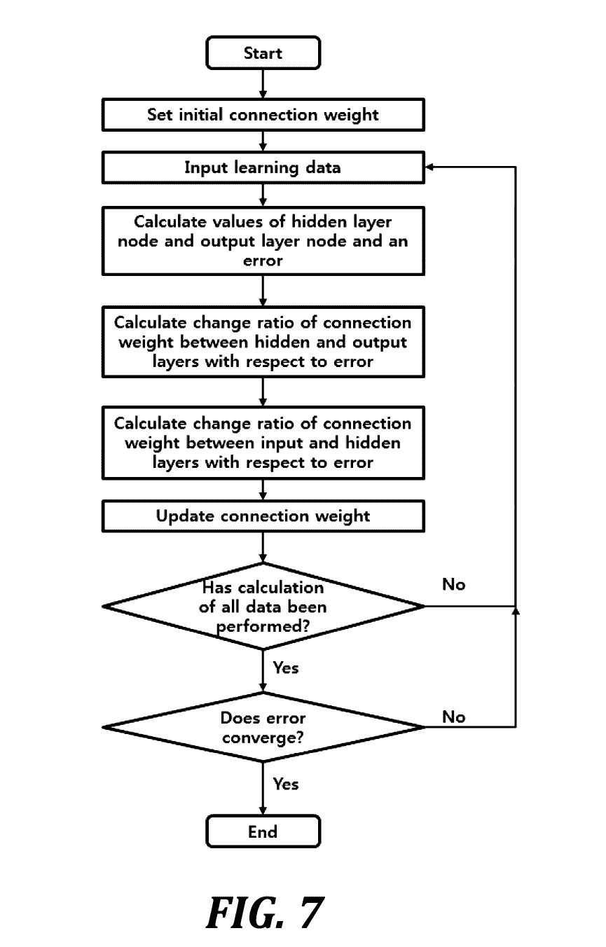

FIG. 1 is a view illustrating a core form of a Korean standard nuclear power plant and installation positions of in-core detector assemblies. FIG. 2 is a view illustrating a disposition of five axial rhodium detectors constituting one in-core detector assembly. FIG. 3 is a flowchart illustrating a method of synthesizing axial power distributions according to an embodiment of the present invention. FIG. 4 is a view illustrating a configuration of a neural network circuit for synthesizing axial power distributions according to the embodiment of the present invention. FIG. 5 is a view illustrating a configuration of a neural network circuit for calculating core average powers of 40 nodes according to an embodiment of the present invention. FIG. 6 is a view illustrating a configuration of a neural network circuit for calculating core average powers of 20 nodes according to another embodiment of the present invention. FIG. 7 is a flowchart illustrating a learning process of the neural network circuit through a back-propagation (BP) algorithm according to an embodiment of the present invention.

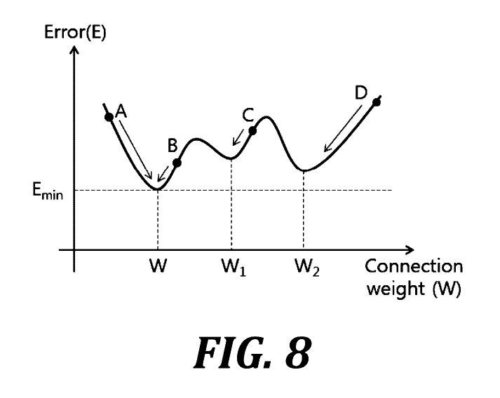

FIG. 8 is a graph illustrating an example in which an error converges on a local or global minimum value through the BP algorithm based on an initial connection weight in the learning of the neural network circuit through the BP algorithm according to the present invention.

The ICOMS according to the present invention is configured to synthesize axial power distributions of a nuclear reactor core based on in-core detector signals measured by an in-core detector assembly 200 integrally provided with a nuclear fuel assembly 100, as shown in FIG. 4.

In this case, the in-core detector assembly 200 is configured with five in-core detectors D₁, D₂, D₃, D₄, and D₅ disposed at a regular distance along the axial direction of the nuclear fuel assembly 100. When an effective core height is set to 100, the in-core detectors D₁, D₂, D₃, D₄, and D₅ are respectively provided at positions of 10%, 30%, 50%, 70%, and 90% of the effective core height, to measure in-core neutron flux signals at five levels in the axial direction of the core.

The in-core detector assembly 200 is inserted into the nuclear reactor core 1 (see FIG. 1) to measure in-core neutron flux signals. In the case of a Korean standard nuclear power plant, a total of 45 in-core detector assemblies 200 (see FIG. 1, corresponding to the in-core detector assemblies 20 of FIG. 1) are inserted into the nuclear reactor core.

Thus, 45 in-core detector signals are generated for each level, axial core average powers of the five levels are calculated based on the 45 generated in-core detector signals for each level, and axial power distributions of the core are synthesized using a neural network circuit, based on the calculated axial core average powers of the five levels.

That is, as described above, the number of in-core detectors D₅ (see FIG. 4) located at 10% of the effective core height is a total of 45 in the radial direction of the core (see FIG. 1). Therefore, dynamic compensation based on a time delay is performed on each of in-core detector signals measured by the 45 in-core detectors, a power of a corresponding nuclear fuel assembly is calculated by providing the compensated signal with a weight value based on a rod shadowing effect and a burnup, and an axial core average power at the position of 10% is then calculated by averaging the powers of the nuclear fuel assemblies.

Thereafter, axial core average powers at the respective levels (i.e., the positions of 10%, 30%, 50%, 70%, and 90% of the effective core height) are calculated in the manner described above, and each of thus calculated axial core average powers of the five levels is normalized as a sum of all core average powers for each level, so that axial power distributions of the nuclear reactor core are synthesized using the normalized axial core average powers of the five levels as input values of the neural network circuit.

Meanwhile, the neural network circuit applied to the synthesization of axial power distributions of the nuclear reactor core according to the present invention includes an input layer, an output layer, and at least one hidden layer, as shown in FIG. 4. The input, hidden, and output layers constituting the neural network circuit are configured with a plurality of nodes LDᵢ, a plurality of nodes Hⱼ, and a plurality of nodes PDₖ, respectively.

In this case, in order to synthesize axial power distributions through learning of the neural network, it is required to determine the number of nodes LDᵢ, the number of nodes Hⱼ, and the number of nodes PDₖ (S110). The numbers of the input and output layer nodes LDᵢ, and PDₖ are naturally determined according to the number of in-core detectors and the number of core average power nodes to be sought so as to synthesize axial power distributions of the core. However, the number of hidden layer nodes Hⱼ is determined through user's experiences and repetitive experiments. As the number of hidden layer nodes Hⱼ increases, the difference between a core average power of the output layer and an actual core average power decreases. However, the processing speed decreases, and therefore, it is required to optimize the number of nodes Hⱼ of the hidden layer.

That is, the input layer is a layer which receives, as input values, the normalized axial in-core average powers of the five levels calculated based on the five in-core detector signals measured by the above-described in-core detectors (corresponding to D₁, D₂, D₃, D₄, and D₅ of FIG. 4). As shown in FIG. 5, the input layer is configured with five input layer nodes LD₁, LD₂, LD₃, LD₄, and LD_{S}. The output layer is a layer which outputs axial core average power node value calculated through the neural network circuit, for synthesizing axial power distributions of the core. The output layer may be configured with 35 to 45 output layer nodes PDₖ as axial power distributions are synthesized through 35 to 45 core average output node values in a general ICOMS. In this embodiment, the output layer is configured with 40 output layer nodes PD₁ to PD₄₀.

The hidden layer is a layer which connects the hidden layer and the input layer to each other between the two layers, and at least one hidden layer may be added between the input layer and the output layer. In the present invention, one hidden layer is used. In the case of the hidden node layer Hⱼ, it is appropriate as the result of repetitive experiments that the number of hidden layer nodes is set to 20 to 30. In this embodiment, the hidden layer is configured with 25 hidden layer nodes H₁ to H₂₅.

Here, the input layer and the hidden layer may be configured to additionally include one bias node B having a bias value when necessary. The numbers of the input, hidden, and output layer nodes LDᵢ, Hⱼ, and PDₖ are not limited to those proposed in this embodiment. It will be apparent that the numbers of the input, hidden, and output nodes LDᵢ, Hⱼ, and PDₖ may be properly selected and used according to the structure of the nuclear reactor or the processing speed of a neural network circuit system and the accuracy of a power value to be sought.

If the numbers of the input, hidden, and output layer nodes LDᵢ, Hⱼ, and PDₖ are determined, the neural network circuit is learned using various core design data (i.e., all data at the beginning, middle, and end of a period of loaded nuclear fuel) applied to the design of the nuclear reactor core of the nuclear power plant, thereby determining optimum connection weights between the respective nodes (S120).

In this case, a BP algorithm is used for learning of the neural network circuit. The BP algorithm, as shown in FIG. 7, determines the optimum connection weights Wᵢⱼ and Wⱼₖ between the respective nodes through a series of processes.

First, arbitrary numbers randomly selected in an arbitrary section (in this embodiment, it is set to select arbitrary numbers in section [−2, 2]) are set to initial connection weights Wᵢⱼ and Wⱼₖ. A value of the hidden layer node Hⱼ is calculated using, as input values of the input layer node LDᵢ, the set initial connection weight Wᵢⱼ between the input layer and the hidden layer and a normalized axial core average power of each level, calculated based on an in-core detector signal, which is included in the design data. A value of the output layer node PDₖ is calculated based on the calculated value of the hidden layer node Hⱼ and the initial connection weight Wⱼₖ between the hidden layer and the output layer.

The value of the output layer node PDₖ calculated as described above is compared with a true value for each node (here, an actual core average power of a corresponding node, which is included in the design data), thereby calculating an error.

Next, in order to update the respective connection weights Wᵢⱼ and Wⱼₖ such that the calculated error can be minimized, the calculated error is partially differentiated using the connection weight Wⱼₖ between the hidden layer and the output layer, thereby calculating a change ratio of the connection weight Wⱼₖ between the hidden layer and the output layer with respect to the error. Also, the error is partially differentiated using the connection weight Wᵢⱼ between the input layer and the hidden layer, thereby calculating a change ratio of the connection weight Wᵢⱼ between the input layer and the hidden layer with respect to the error.

Thereafter, the connection weight Wⱼₖ between the hidden layer and the output layer and the connection weight Wᵢⱼ between the input layer and the hidden layer are updated in the opposite direction of a change ratio having influence on the error, based on the respective calculated change ratios of the connection weights, and the above-described process is repeatedly performed on a set of various design data (i.e., in-core detector signals and actual core average power data corresponding thereto) applied to the design of the nuclear reactor core, thereby calculating a performance index of a learning result value from a difference between a core average power value obtained from the neural network circuit and an actual core average power value shown in the design data. When the calculated performance index is equal to or smaller than a previously set measurement limit value, the BP algorithm is considered to converge, and the learning using the BP algorithm is finished, thereby optimizing the connection weights Wᵢⱼ and Wⱼₖ among the respective nodes LDᵢ, Hⱼ, and PDₖ.

Here, the hidden layer node and the output layer node except for the bias node and the input layer node have a differentiable active function (generally, a hyperbolic tangent function in a sigmoid form is frequently used) for the purpose of learning, and values of the hidden layer node Hⱼ and the output layer node PDₖ are calculated by the following Equations 2 and 3. Accordingly, the performance index of the learning result value can be obtained from the following Equation 4.

$${H}_{j} = a ( {\sum }_{i = 1}^{n} ( {W}_{i , j} \times {LD}_{i} ) + {W}_{n + 1 , j} \times B ) \qquad Equation 2$$

Here, Hⱼ is a value of a j^{th} hidden layer node, n is the number of input layer nodes except for the bias node, W_{i,j} is a connection weight (weight value) between an i^{th} input layer node and the j^{th} hidden layer node, LDᵢ is a value of the i^{th} input layer node, B is the bias node, and a(x) is an active function of the hidden layer node.

$${PD}_{k} = a ( {\sum }_{j = 1}^{n} ( {W}_{j , k} \times {H}_{j} ) + {W}_{n + 1 , k} \times B ) \qquad Equation 3$$

Here, PDₖ is a value of a k^{th} output layer node, n is the number of hidden layer nodes except for a bias node, W_{j,k} is a connection weight (weight value) between the j^{th} hidden layer node and the k^{th} output layer node, Hⱼ is a value of the j^{th} hidden layer node, B is the bias node, and a(x) is an active function of the output layer node.

$$Performance Index = \frac{1}{N} {\sum }_{i = 1}^{N} \{ \frac{1}{L - M + 1} {\sum }_{j = M}^{L} \frac{1}{2} {( \frac{{o}_{ij} - {t}_{j}}{{t}_{j}} )}^{2} \} \qquad Equation 4$$

Here, L and M are node numbers used in error calculation, where the calculation is being performed from M^{th} node to L^{th} node, oᵢⱼ is a calculation result value of the neural network circuit at a j^{th} node at i^{th} test case, tⱼ is a true value at the j^{th} node, and N is the number of test cases used in learning.

It should be noted that in the learning of the neural network circuit through the BP algorithm described above, the error between the true value and the result value calculated through the neural network circuit does not converge on a global minimum value but converges on a local minimum value according to the arbitrarily selected initial connection weight, and therefore, an optimum connection weight where an actual error is minimized may not be found.

FIG. 8 is an illustrating example in which an error converges on a local or global minimum value through the BP algorithm based on an initial connection weight in the learning of the neural network circuit through the BP algorithm according to the present invention. As shown in FIG. 8, owing to characteristics of the BP algorithm, the error converges in the direction where the error decreases. Hence, when a connection weight at point A or B is set as the initial connection weight, the error converges in the direction where the error decreases, so that an optimum connection weight W where the error is the local minimum value can be found. However, there is a problem in that when a connection weight at point C or D is set as the initial connection weight, a connection weight W₁ or W₂ at a point where the error is the local minimum value is merely found, but the optimum connection weight W is not found.

In order to solve such a problem, in the present invention, an SA method is applied together with the BP algorithm in the learning of the neural network circuit for synthesizing axial power distributions, thereby more accurately synthesizing axial power distributions.

Here, the SA method, which is a probabilistic search algorithm which enables to search over the entire region of a solution space, is a technique technologically applying a process of finally stabilizing a metal into a crystal form having the minimum energy when the metal in a liquid state is cooled down through an annealing process. The SA method performs the global optimization by repeating a process of probabilistically determining a new solution from a current solution.

One of important features of the SA method is that it is possible to transfer the current solution to a solution having a cost function value inferior to the current solution. As shown in FIG. 8, although the optimum connection weight converges on the connection weight W₁ or W₂ where the error is the local minimum value, the SA method enables to search over the entire region out of the connection weight Wᵢ or W₂, so that the actual optimum connection weight W can be founded.

The SA method described above is a general probabilistic meta algorithm with respect to a global optimization issue. The SA method is a method applied in various fields so as to derive an optimum solution in a process of deriving a convergence value. In this specification, detailed description of the SA method will be omitted.

Subsequently, if the optimum connection weights Wᵢⱼ and Wⱼₖ between the respective nodes are determined through the above-described process, core average powers for the respective nodes are calculated based on the normalized core average powers of the five levels, calculated based on the in-core detector signals measured by the in-core detectors D₁, D₂, D₃, D₄, and D₅ during the operation of the nuclear reactor, using the neural network circuit (S130), and axial power distributions of the nuclear reactor core are synthesized based on the calculated core average powers for the respective nodes (S140).

Meanwhile, in this embodiment, the neural network circuit configured with 40 output layer nodes PD₁ to PD₄₀ is described, but the present invention is not limited thereto. The number of output layer nodes constituting the neural network circuit may be modified and applied so as to reduce the quantity of data sets loaded into the ICOMS and the time required to perform learning of the neural network circuit.

That is, when a neural network circuit configured with 40 output layer nodes PD₁ to PD₄₀ is used, data on connection weights Wᵢⱼ and Wⱼₖ between the respective nodes constituting the neural network circuit are all to be loaded as basic data in the ICOMS so as to synthesize axial power distributions using the neural network circuit. Therefore, the quantity of data sets loaded into the ICOMS is increased. In addition, the time required to perform learning of the neural network circuit for finding optimized values of the connection weights Wᵢⱼ and Wⱼₖ also increases.

Thus, in another embodiment of the present invention, if the number of output layer nodes constituting the neural network circuit is changed into 15 to 20, the number of data on the connection weights Wᵢⱼ and Wⱼₖ between the respective nodes can remarkably decrease as compared with when the neural network circuit is configured with 40 output layer nodes. Thus, it is possible to easily maintain and manage data loaded into the ICOMS. In addition, it is possible to relatively more remarkably reduce the time required to perform learning of the neural network circuit for finding optimized values of the connection weights Wᵢⱼ and Wⱼₖ.

That is, as shown in FIG. 6, when the number of output layer nodes constituting the neural network circuit is changed to 20, the input layer constituting the neural network circuit, like the above-described embodiment, is configured with five input layer nodes LD₁, LD₂, LD₃, LD₄, and LD₅, but the output layer is configured with 20 output layer nodes PD₁ to PD₂₀. Therefore, the hidden layer may be configured with 10 to 20 hidden layer nodes Hⱼ, preferably 15 hidden layer nodes H₁ to H₁₅.

In this case, when axial core average powers of 40 nodes are required to synthesize axial power distributions of the core, the axial core average powers of the 40 nodes may be derived through an interpolation, based on the axial core average powers of the 20 nodes, obtained through the above-described process.

The representative interpolation applicable to the above-described case may include a Newton interpolation, a Lagrange interpolation, a Hermite interpolation, a spline interpolation, and the like. In addition, it will be apparent that all of the other various interpolations may be applied in a variety of manners.

As described above, according to the present invention, using a neural network circuit configured to include an input layer, an output layer, and at least one hidden layer, each layer being configured with at least one node, each node of one layer being connected to nodes of the other layers, node-to-node connections being made with connection weights varied based on a learning result, optimum connection weights between the respective nodes constituting the neural network circuit are determined through learning based on various core design data applied to the design of a nuclear reactor core of a nuclear power plant, and axial power distributions of the nuclear reactor core are synthesized based on in-core detector signals measured by in-core detectors during operation of a nuclear reactor, so that it is possible to solve a problem that actual axial power distributions are not properly replicated as a calculation error gradually increases since after the middle of the period in which the shape of the axial power distribution has a saddle form in the conventional ICOMS using a Fourier series, thereby more accurately replicating axial power distributions of the nuclear reactor core throughout an overall period of the nuclear fuel, and so that a buckling constant is commonly applied to all nuclear power plants having different kinds of cores and design characteristics without the need for selecting and applying different optimum buckling constants for correcting the Fourier series at the respective nuclear power plants having the different kinds of cores and design characteristics, thereby more accurately replicating axial power distributions of the core.

Further, in the present invention, axial core average powers of the nuclear reactor core can be directly calculated through the neural network circuit, based on in-core detector signals measured by in-core detectors located at five levels, so that a buckling constant is commonly applied to all nuclear power plants having different kinds of cores and design characteristics without the need for selecting and applying different optimum buckling constants for correcting the Fourier series at the respective nuclear power plants having the different kinds of cores and design characteristics, thereby more accurately replicating axial power distributions of the core.

The scope of the present invention is not limited to the embodiment described and illustrated above but is defined by the appended claims. It will be apparent that those skilled in the art can make various modifications and changes thereto within the scope of the invention defined by the claims. Therefore, the true scope of the present invention should be defined by the technical spirit of the appended claims.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method of synthesizing axial power distributions of a nuclear reactor core using a neural network circuit, which is applied to an in-core monitoring system for monitoring an operation state of a nuclear reactor based on in-core detector signals measured by a plurality of in-core detector assemblies, wherein the neural network circuit comprises an input layer configured to receive a core average power of the nuclear reactor core for each of a plurality of axial levels, calculated based on in-core detector signals measured by the plurality of in-core detector assemblies; an output layer configured to output an axial core average power for each node calculated through the neural network circuit; and at least one hidden layer interposed between the input layer and the output layer to connect the two layers to each other, and
wherein each of the input, output, and hidden layers is configured with at least one node, each node of one layer being connected to nodes of the other layers, node-to-node connections being made with connection weights varied based on a learning result, so that optimum connection weights between the respective nodes constituting the neural network circuit are determined through repetitive learning based core design data applied to the design of the nuclear reactor core of a nuclear power plant.

2. The method according to claim 1, wherein the in-core detector assemblies comprise a plurality of in-core detectors inserted into some nuclear fuel assemblies in the nuclear reactor core, the plurality of in-core detectors, when an effective core height of the nuclear reactor core is set to 100, being respectively provided at positions of 10%, 30%, 50%, 70%, and 90% of the effective core height, to measure in-core neutron flux signals of five levels in the axial direction of the core, and
wherein the input layer is configured with five input layer nodes which receive a core average output power for each of the five levels.

3. The method according to claim 2, wherein the core average output power for each of the five levels is a core average power obtained by performing dynamic compensation based on a time delay on an in-core detector signal measured by the in-core measurements for each of the five levels, and normalizing, with a sum of average powers of the five levels, the core average powers of the five levels, calculated by providing the compensated signal with a weight value based on a rod shadowing effect a burnup.

4. The method according to claim 2, wherein the output layer is configured with 15 to 45 output layer nodes which output a core average power of the nuclear reactor.

5. The method according to claim 4, wherein the hidden layer is configured with 10 to 30 hidden layer nodes which are interposed between the input and output layers to be connected to the respective nodes constituting the input and output layers.

6. The method according to claim 5, wherein the output layer is configured with 40 output layer nodes, and the hidden layer is configured with 25 hidden layer nodes.

7. The method according to claim 5, wherein the output layer is configured with 20 output layer nodes, and the hidden layer is configured with 15 hidden layer nodes.

8. The method according to claim 7, wherein the method further comprises a process of calculating an axial core average power for each of the 40 nodes through an interpolation, based on values of the 20 output layer nodes.

9. The method according to claim 8, wherein the interpolation is any one of a Newton interpolation, a Lagrange interpolation, a Hermite interpolation, and a spline interpolation.

10. The method according to claim 1, wherein the input layer further comprises a bias node having a bias value.

11. The method according to claim 1, wherein the hidden layer further comprises a bias node having a bias value.

12. The method according to claim 1, wherein the neural network circuit determines optimum connection weights between the respective nodes through repetitive learning using a back-propagation (BP) algorithm.

13. The method according to claim 12, wherein the neural network circuit additionally performs a process of optimizing the connection weights obtained using the BP algorithm through a simulated annealing (SA) method.

14. An in-core monitoring system in which axial power distributions are synthesized based on in-core detector signals measured by in-core detectors of a nuclear reactor, through the method of claim 1.
